(19) United States
(12) Patent Application Publication
(10) Pub. No.: US 2008/0144961 A1
(43) Pub. Date: Jun. 19, 2008

(54) Method and Image Evaluation Unit for Scene Analysis

(75) Inventors: Martin Litzenberger, Bruck An Der Leitha (AT); Bernhard Kohn, Wien (AT); Peter Schon, Wien (AT); Michael Hofstatter, Perchtoldsdorf (AT); Nikolaus Donath, Wien (AT); Christoph Posch, Wien (AT); Nenad Milosevic, Wien (AT)

Correspondence Address: LERNER GREENBERG STEMER LLP, P O BOX 2480, HOLLYWOOD, FL, 33022-2480, US

(73) Assignee: AUSTRIAN RESEARCH CENTERS GMBH-ARC, Wien (AT)

(21) Appl. No.: 11/957,709

(22) Filed: Dec. 17, 2007

Related U.S. Application Data
(63) Continuation of application No. PCT/AT2006/000245, filed on Jun. 14, 2006.

(30) Foreign Application Priority Data
Jun. 15, 2005 (AT) A 1011/2005

(51) Int. Cl. G06K 9/38; G06K 9/60

(52) U.S. Cl. 382/270; 382/302

(57) ABSTRACT

A method is used for analyzing scenes. The scene or objects in the scene and an optical sensor perform a relative movement and the scene information obtained is evaluated. Visual information of the scene is detected by the individual pixels of the optical sensor and pixel co-ordinates of established variations in intensity are determined. A temporization of the established variations in intensity is determined and a local accumulation of the variations in intensity is determined by statistical methods. The local accumulations are evaluated in terms of the number and/or position thereof by statistical methods and data area clearing methods. The determined values are used as parameters of a detected scene region. A parameter is compared with a pre-determined parameter considered characteristic of an object, and when the pre-determined comparison criteria are fulfilled, the evaluated local amassment associated with the respective scene region is seen as an image of the object.

### CROSS-REFERENCE TO RELATED APPLICATIONS

This is a continuing application, under 35 U.S.C. § 120, of copending international application No. PCT/AT2006/000245, filed Jun. 14, 2006, which designated the United States; this application also claims the priority, under 35 U.S.C. § 119, of Austrian patent application No. A 1011/2005, filed Jun. 15, 2005; the prior applications are herewith incorporated by reference in their entirety.

### BACKGROUND OF THE INVENTION

### FIELD OF THE INVENTION

The invention relates to a method for scene analysis in which scene information is recorded with an optical sensor. The scene or the objects in the scene and the optical sensor perform a relative movement and the scene information obtained is evaluated.

The invention deals with the processing of information that is recorded by optical sensors.

### BRIEF SUMMARY OF THE INVENTION

It is accordingly an object of the invention to provide a method and an image evaluation unit for scene analysis that overcomes the above-mentioned disadvantages of the prior art methods and devices of this general type, which is based on a special optical semiconductor sensor with asynchronous, digital data transmission to a processing unit, in which special algorithms are implemented for the scene analysis. The method delivers selected information about the contents of a scene, which can be evaluated and e.g. used to control machines or installations or the like.

With the foregoing and other objects in view there is provided, in accordance with the invention a method for performing a scene analysis in which scene information is recorded with an optical sensor. A scene or any objects in the scene and the optical sensor perform a relative movement and the scene information obtained is evaluated. The method includes detecting visual information of the scene from pixels of the optical sensor. The pixels emit an output signal when an absolute change in intensity exceeds a given threshold value or a relative change in intensity of recorded light which is considered relevant for a relative movement takes place between a recorded scene point and the optical sensor and/or for a change in scene contents. Locations or pixel coordinates of ascertained changes in intensity are determined and recorded. A temporization of established intensity changes are determined and recorded. Local accumulations of the intensity changes of the pixels are determined using statistical methods. The local accumulations are evaluated using further statistical methods with regard to a chronological change in an accumulation density and/or a change of a local distribution, resulting in values determined being parameters of a detected scene region. At least one of the parameters is compared with at least one given parameter being a characteristic for an object. If predetermined comparison criteria are fulfilled, then it is determined that an evaluated local accumulation associated with a respective scene region is an image of the object.

The sensors used forward or emit the pre-processed scene information asynchronously in the form of signals, namely only when the scene experiences changes or individual image elements of the sensors detect specific features in the scene. This principle reduces the resultant data sets considerably in comparison to an image display and simultaneously increases the information contents of the data by already extracting properties of the scene.

The scene detection with conventional, digital image processing is based on the evaluation of image information that is delivered by an image sensor. Usually, the image is thereby read out sequentially from the image sensor in a given cycle (synchronously) several times per second, image point by image point, and the information about the scene that is contained in the data is evaluated. Due to the large data sets and expensive evaluation methods, even when using appropriately efficient processor systems, this principle is limited with the now described difficulties.

1.) The data rate of digital transmission channels is limited and not sufficiently large for some tasks of high-performance image processing.

2.) Efficient processors consume too much power for many, in particular, mobile applications.

3.) Efficient processors require active cooling. Systems which operate with processors of this type can therefore not be built sufficiently compact for many applications.

4.) Efficient processors are too expensive for many fields of application.

With the method according to the invention, a quick processing of the signals and a correspondingly quick identification of significant information in the scene observed takes place. The statistical methods used perform an exact evaluation with respect to interesting scene parameters or identification of objects.

In accordance with an added mode of the invention, there is the step of studying the local accumulations with respect to linear associated changes in intensity which moved over the recorded scene and that intensity changes of this type, which are evaluated as associated or exceeding a preset quantity, are seen as a trajectory of an object moving relative to the optical sensor.

In accordance with an additional mode of the invention, there is the step of interpreting a change in a size of a local accumulation as an object approaching the optical sensor or moving away from the optical sensor.

In accordance with the invention, a chronological and/or a spatial change in a structure of the local accumulations are seen as characteristic for a specific feature of a scene region.

In accordance with a further mode of the invention, there is the step of monitoring and integrating, in each of the pixels, a change of a photocurrent occurring due to changes in intensity, and if a threshold value of a pixel is exceeded, emitting immediately a signal asynchronously to a processing unit, and that summation or integration starts again after each signal emission.

In accordance with a further mode of the invention, there are the further steps of detecting and determining positive and negative changes of a photocurrent, separately, and evaluating the positive and negative changes of the photocurrent.

In accordance with an additional mode of the invention, there is the step of performing the temporization of the established intensity changes with regard to time and sequence.

In accordance with another additional mode of the invention, there is the step of selecting the statistical methods from the group of averaging, histograms, concentration on crucial points, document forming methods, order forming methods, and filtering over time. In addition, the further statistical methods are selected from the group of weighting, setting threshold values with respect to number and position, and data area clearing methods.

In accordance with a further additional mode of the invention, there is the step of performing the comparing step by comparing a number of parameters with a number of given parameters which are considered characteristic for the object.

In accordance with a concomitant mode of the invention, there is the step of selecting the parameters from the group of size, speed, direction of movement, and form.

Other features which are considered as characteristic for the invention are set forth in the appended claims.

Although the invention is illustrated and described herein as embodied in a method and an image evaluation unit for scene analysis, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1A and 1B are block diagrams for illustrating differences between the customary methods of the prior art and the method according to the invention;

FIG. 2 is diagram showing an image evaluation unit according to the invention; and

FIGS. 3A, 3B, 4 and 5 are recorded images for explaining the method according to the invention.

### DETAILED DESCRIPTION OF THE INVENTION

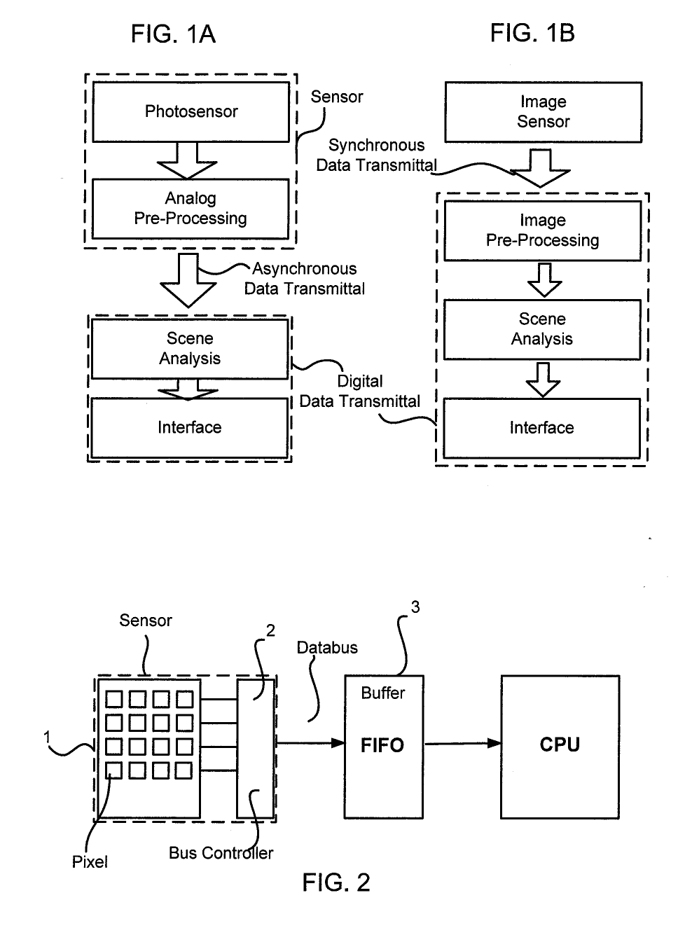

Referring now to the figures of the drawing in detail and first, particularly, to FIGS. 1A and 1B thereof, there is shown a difference between the prior art and the method according to the invention. To date, the information or data delivered by an image sensor were synchronously forwarded and, after a digital image pre-processing and scene analysis, the results were transmitted via an interface of the apparatus (FIG. 1B).

According to the invention, the image signals of the optical sensor are processed in a specific manner, namely in such a way that the intensity information recorded by a photo-sensor in the image elements of the optical sensor is pre-processed by an analog, electronic circuit. Quite generally, it is noted that the processing of the signals of several adjacent photo-sensors can be combined in an image element. The output signals of the image elements are asynchronously transmitted via an interface of the sensor to a digital data evaluation unit in which a scene analysis is carried out, and the result of the evaluation is made available to an interface of the apparatus (FIG. 1A).

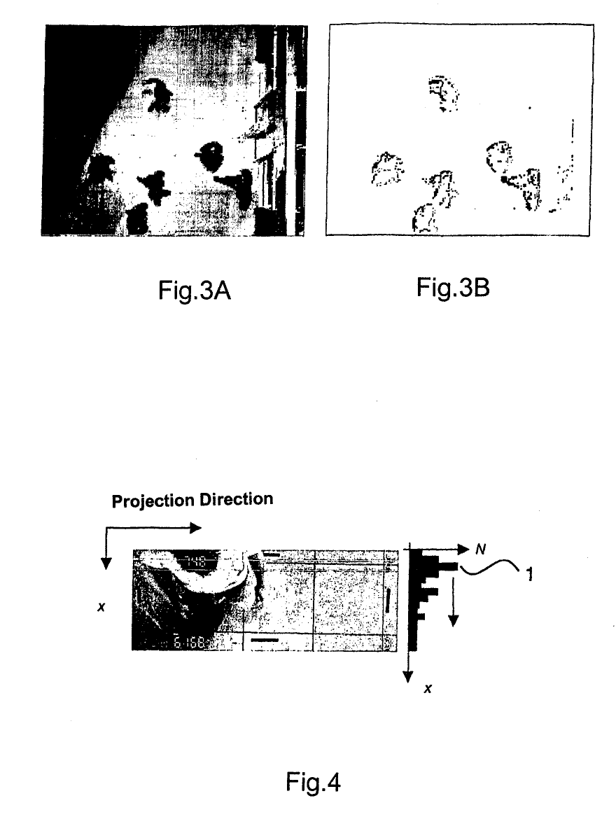

The method according to the invention is schematically described with reference to FIG. 2. A scene is thereby shown on an image plane of an optical sensor 1 via a non-illustrated optical recording unit. Visual information is detected by the image elements of the sensor and continuously processed in electronic circuits in the image elements. Specific features are identified in the scene contents by this processing in real time. Features that are to be detected in the image contents can be, among other things, static edges, local changes in intensity, optical flow, etc.

The detection of a feature will be described as an “event” in the following. With each occurrence of an event, a digital output signal is generated in real time by the image element at the asynchronous data bus. This signal contains the address of the image element and thus the coordinates in the image field at which the feature was identified. This data will be called “address-event” (AE) in the following. In addition, further properties of the feature, in particular the time of the occurrence, can be coded in the data. The sensor 1 sends this information as relevant data via the asynchronous data channel to a processing unit CPU. A bus controller 2 prevents data collisions on the transmission channel. In some cases, it may be advantageous to use a buffer storage 3, e.g. a FIFO, between the sensor and the processing unit to balance irregular data rates due to the asynchronous transmission protocol (FIG. 2).

The method according to the invention relates to the combination of the specially designed sensor, the data transmission and the provided statistical/mathematical methods for data processing. The sensor detects changes in light intensity and thus reacts e.g. to moving edges or light/dark boundary lines in a scene. The sensor tracks the changes of a photocurrent of the photo-sensor in each image element. These changes are added in an integrator for each image element. When the sum of the changes exceeds a threshold value, the image element sends this event immediately, asynchronously via a data bus, to the processing unit. After each event, the value of the integrator is deleted. Positive and negative changes of the photocurrent are processed separately and generate events of different polarity (so-called “on” and “off” events).

The sensor used does not generate any images in the conventional sense. However, for a better understanding, two-dimensional illustrations of events are used in the following. For this purpose, the events for each image element are counted within a time interval. A white image point is allocated to image elements (pixels) without events. Image elements (pixels) with “on” or “off” events are shown with grey or black image points.

Terms are introduced for the following embodiments to prevent confusion with terms from digital image processing.

An AE frame is defined as the AEs, stored in a buffer storage, which were generated within a defined time interval.

An AE image is the illustration of an AE frame in an image in which colors or gray values are allocated to polarity and frequency of the events.

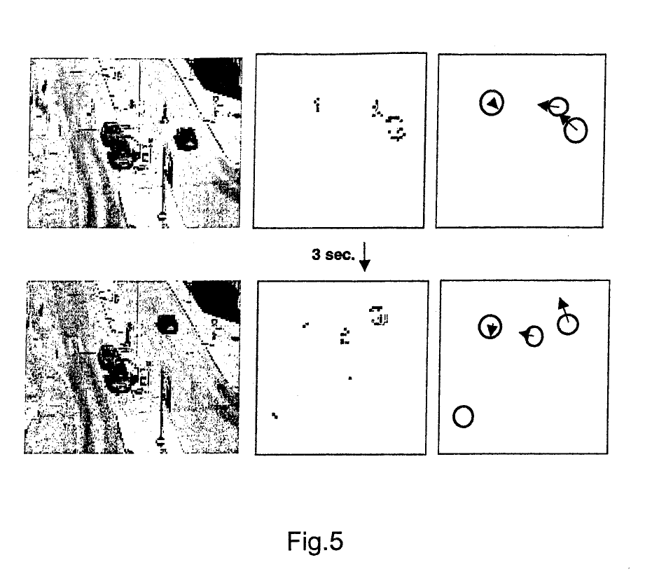

FIG. 3A shows a video image of a scene and FIG. 3B shows an AE image of the same scene, produced by a sensor that reacts to changes in light intensity. In the data processing unit CPU, the features from the scene are studied using statistical/mathematical methods and abstract information of higher valence about the scene contents obtained. Such information can be e.g. the number of persons in a scene or the speed and distance of vehicles on a street.

It can be easily seen that the data set is considerably less than in the original image. The processing of events requires fewer calculations and storage than in digital image processing and can therefore be accomplished much more efficiently.

A room counter for people can be realized by mounting the image sensor, for example, on the ceiling in the middle of a room. The individual events are allocated by the processing unit to corresponding square zones in the image field that have the approximate size of a person. A simple evaluation of the surface covered with moving objects is possible via simple statistical methods and a correction mechanism. This is proportional to the number of persons in the field of vision of the sensor. The calculation expense for the number of persons is low in this case, so that this system can be realized with simple and cost-effective microprocessors. If no persons or objects are moving in the image field of the sensor, no events are generated and the microprocessor can switch to a power-saving mode that significantly minimizes the power consumption of the system. This is not possible in image processing systems according to the prior art, because the sensor image must be processed at all times and examined for people.

For a door counter for people, the image sensor is mounted above the door or another entrance or exit of a room. The people are not distorted perspectively and the AEs are projected on axes (e.g.: vertical axes) when persons cross through the observation area and in this way added in a histogram (FIG. 4). If a person moves through the door under the sensor, one or more peaks 1, extending in direction of movement, can be detected in the histogram. By use of statistical weighting, the calculation of the maximum and the direction of movement can be secured against malfunctions. For each AE frame, the index of the histogram is determined which contains the largest number of events and it is compared with the index of the last AE frame. If the index shifts, it is an indicator for the fact that the person is moving and the probability for the corresponding direction of movement is increased. The probability increases until a threshold value is attained. In this case, the person is counted and both probabilities are reset to defined values. In this way, it is possible for the system to differentiate between incoming and outgoing persons and to increase or decrease a counter when persons enter or leave the room. Resetting both probabilities has shown to be advantageous in order to make the algorithm more secure when high activity prevails in the field of vision. By selecting negative values, an artificial time constant is introduced to avoid duplicate counting of persons. Several persons who are walking parallel can be identified by a division of the projection areas into various “tracks” along the direction of movement.

Many safety paths are identified by warning lights that warn drivers about pedestrians. These warning lights flash around the clock and are often ignored by car drivers, since they do not indicate any actual danger in most cases. Intelligent sensors, which only release a warning signal when a pedestrian crosses the street or approaches the safety path, can contribute to improving traffic safety by paying greater attention to warning lights. For automatic activation of warning lights at safety paths, an image sensor and a digital processor are used which are able to monitor safety paths and their immediate surroundings, and to identify objects (persons, bicyclists, . . . ) who are crossing the street.

The proposed system containing an image sensor and a simple digital processing unit is capable of segmenting and tracking persons and vehicles in the vicinity of the safety path, and on it, in the data flow (FIG. 5). The size and speed of the objects identified by the system enables a division into the categories pedestrian and vehicles. FIG. 5 shows a scene recorded by the sensor at two points in time, which detects the corresponding AE images and the result of the mathematical/statistical evaluation which identifies the individual objects and their direction of movement. After a certain observation period, it is possible for the system to identify the position and orientation of streets, sidewalks and safety paths by using learning methods based on static conception. Consequently, a warning can then be issued about every pedestrian who is moving toward the safety path or on the safety path. Pedestrians who move e.g. on sidewalks parallel to the roadway do not release any warning due to their identified direction of movement.

Systems with simple sensors (e.g. infrared movement sensors) are only able to identify the presence of persons in the vicinity of safety paths, however, they cannot detect their direction of movement and thus warn specifically about pedestrians who are directly on the safety paths.

1. A method for performing a scene analysis in which scene information is recorded with an optical sensor, a scene or any objects in the scene and the optical sensor perform a relative movement and the scene information obtained is evaluated, which comprises the steps of:
detecting visual information of the scene from pixels of the optical sensor, the pixels emitting an output signal when an absolute change in intensity exceeds a given threshold value or a relative change in intensity of recorded light which is considered relevant for a relative movement taking place between a recorded scene point and the optical sensor and/or for a change in scene contents;
determining and recording one of locations and pixel coordinates of ascertained changes in intensity;
determining and recording a temporization of established intensity changes;
determining local accumulations of the intensity changes of the pixels using statistical methods;
evaluating the local accumulations with further statistical methods with regard to at least one of a chronological change in an accumulation density and a change of a local distribution, resulting in values determined being parameters of a detected scene region;
comparing at least one of the parameters with at least one given parameter being a characteristic for an object; and
if predetermined comparison criteria are fulfilled, determining that an evaluated local accumulation associated with a respective scene region is an image of the object.

2. The method according to claim 1, which further comprises studying the local accumulations with respect to linear associated changes in intensity which moved over the recorded scene and that intensity changes of this type, which are evaluated as associated or exceeding a preset quantity, are seen as a trajectory of an object moving relative to the optical sensor.

3. The method according to claim 1, which further comprises interpreting a change in a size of a local accumulation as one of an object approaching the optical sensor and moving away from the optical sensor.

4. The method according to claim 1, wherein a chronological and/or a spatial change in a structure of the local accumulations are seen as characteristic for a specific feature of a scene region.

5. The method according to claim 1, which further comprises monitoring and integrating, in each of the pixels, a change of a photocurrent occurring due to changes in intensity, and if a threshold value of a pixel is exceeded, emitting immediately a signal asynchronously to a processing unit, and that one of summation and integration starts again after each signal emission.

6. The method according to claim 1, which further comprises:
detecting and determining positive and negative changes of a photocurrent, separately; and
evaluating the positive and negative changes of the photocurrent.

7. The method according to claim 1, which further comprises performing the temporization of the established intensity changes by time and sequence.

8. The method according to claim 1, which further comprises selecting the statistical methods from the group consisting of averaging, histograms, concentration on crucial points, document forming methods, order forming methods, and filtering over time.

9. The method according to claim 1, which further comprises selecting the further statistical methods from the group consisting of weighting, setting threshold values with respect to number and position, and data area clearing methods.

10. The method according to claim 1, which further comprises performing the comparing step by comparing a number of parameters with a number of given parameters which are considered characteristic for the object.

11. The method according to claim 1, which further comprises selecting the parameters from the group consisting of size, speed, direction of movement, and form.

12. An image evaluation configuration for recording scene information, wherein a scene or any objects in the scene and an optical sensor perform a relative movement to one another, the optical sensor having pixels for detecting visual information of the scene, the pixels emitting an output signal when an absolute change in intensity exceeds a preset threshold value or when a relative change in intensity of recorded light which is relevant for a relative movement taking place between a recorded scene point and the optical sensor and/or for a change in scene contents, the image evaluation configuration comprising:
an unit for determining locations or pixel coordinates of ascertained changes in intensity and for determining a temporization of ascertained intensity changes;
a calculator unit coupled to said unit and in which local accumulations of the intensity changes of the pixels are determined with statistical methods;
an evaluation unit for evaluating the local accumulations using further statistical methods with regard to a chronological change in at least one of accumulation density and a change in a local distribution, resulting in values determined representing parameters of a detected scene region; and
a comparison unit coupled to said evaluation unit and comparing at least one of said parameters with at least one preset parameter being characteristic for an object, and when a predetermined comparison criteria is fulfilled, an evaluated local accumulation associated with a respective scene region is seen as an image of the object.

13. The image evaluation configuration according to claim 12, wherein said unit determines the temporization of the ascertained intensity changes with regard to point in times and sequencing.

14. The image evaluation configuration according to claim 12, wherein said statistical methods are selected from the group consisting of averaging, histograms, concentration on crucial points, document forming methods, order forming methods, and filtering over time.

15. The image evaluation configuration according to claim 12, wherein said further statistical methods are selected from the group consisting of weighting, setting threshold values with respect to at least one of number and position, and data area clearing methods.

16. The image evaluation configuration according to claim 12, wherein said parameters are selected from the group consisting of size, speed, direction of movement, and form.

17. The image evaluation configuration according to claim 12, wherein said comparison unit compares a number of said parameters with a number of preset parameters.

18. A computer-readable medium having computer-executable instructions for performing the method according to claim 1.
